(19) United States
(12) Patent Application Publication
(10) Pub. No.: US 2026/0253961 A1
(43) Pub. Date: Aug. 27, 2026

(54) Hot-Press Formation Electrolyte and Battery Cell

(71) Applicant: GM Global Technology Operations LLC, Detroit, MI (US)

(72) Inventors: Zhe Li, Shanghai (CN); Qili Su, Shanghai (CN); Haijing Liu, Shanghai (CN)

(21) Appl. No.: 19/091,076

(22) Filed: Mar. 26, 2025

(30) Foreign Application Priority Data
Feb. 26, 2025 (CN) 202510225476.3

(51) Int. Cl. H01M 10/0569; H01M 4/04; H01M 4/36; H01M 4/38; H01M 4/505; H01M 4/525; H01M 4/587; H01M 4/62; H01M 10/0525; H01M 10/0568; H01M 10/42

(52) U.S. Cl. CPC H01M 10/0569; H01M 4/0447; H01M 4/364; H01M 4/386; H01M 4/505; H01M 4/525; H01M 4/587; H01M 4/622; H01M 10/0525; H01M 10/0568; H01M 10/4235; H01M 2300/0034; H01M 2300/004

(57) ABSTRACT

An electrolyte for a battery cell, a battery cell for a vehicle and a method of forming a battery cell. The electrolyte includes a combination of lithium ion salts including lithium hexafluorophosphate (LiPF₆), lithium bis(fluorosulfonyl)imide, and lithium difluoro(oxalato)borate. The electrolyte also includes a carbonate solvent including fluoroethylene carbonate, ethyl methyl carbonate, and a carboxylic acid ester exhibiting the following formula:

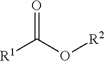

wherein R¹ and R² are individually an unsubstituted alkyl group including in the range of 1 carbon to 2 carbons, wherein the combination of lithium ion salts is dispersed in the carbonate solvent. The electrolyte further includes vinylene carbonate. The electrolyte does not include ethyl carbonate.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel.

In an effort to increase battery capacity and satisfy the increased energy demands found in diverse industries, the use of silicon and silicon alloys, in combination with graphite, has been examined as a potential anode material. Silicon based anodes can benefit from hot-press formation, which uses elevated temperatures and pressures during the 0process of initially charging and discharging a battery cell. However, when exposed to the temperatures and pressures used in hot-press formation, ethyl carbonate based electrolytes, which are commonly used electrolyte materials in lithium ion batteries, undergo side reactions that may result in unstable interfaces at the electrodes. In addition, the ethyl carbonate may react with oxygen liberated by the cathode, which also reduces thermal stability. These unstable interfaces and reduced thermal stability may reduce battery performance, including reductions in battery capacity, cycle life, and thermal performance.

Thus, while present electrolyte chemistries and other battery materials achieve their intended purpose, there is a need for new and improved electrolyte chemistries for lithium ion batteries including silicon in the anodes that offer relatively improved performance after hot-press formation.

### SUMMARY

According to various aspects, the present disclosure relates to an electrolyte for a battery cell. The electrolyte includes a combination of lithium ion salts including lithium hexafluorophosphate (LiPF₆), lithium bis(fluorosulfonyl)imide, and lithium difluoro(oxalato)borate. The electrolyte also includes a carbonate solvent including fluoroethylene carbonate, ethyl methyl carbonate, and a carboxylic acid ester exhibiting the following formula:

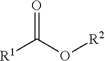

wherein R¹ and R² are individually an unsubstituted alkyl group including in the range of 1 carbon to 2 carbons, wherein the combination of lithium ion salts is dispersed in the carbonate solvent. The electrolyte further includes vinylene carbonate. The electrolyte does not include ethyl carbonate.

In embodiments of the above, the lithium hexafluorophosphate is present in the carbonate solvent at a concentration (moles (mol) of salt per liter (L) of solvent) of 0.4 mol/L (M) to 1.2 M, the lithium bis(fluorosulfonyl)imide is present in the carbonate solvent at a concentration in the range of 0.1 M to 0.4 M, and the lithium difluoro(oxalato)borate is present in the carbonate solvent at a concentration in the range of 0.05 M to 0.3 M.

In any of the above embodiments, the carboxylic acid ester is at least one of ethyl propionate, methyl acetate, ethyl acetate, and methyl propionate.

In further embodiments, the carboxylic acid ester is present in the carbonate solvent in a range of 1 percent by volume to 50 percent of the total volume of the carbonate solvent, the fluoroethylene carbonate is present in the range of 1 percent by volume to 50 percent by volume of the total volume of the carbonate solvent, and the ethyl methyl carbonate is present in the carbonate solvent the range of 10 percent by volume to 90 percent by volume of the total volume of the carbonate solvent.

In any of the above embodiments, the vinylene carbonate is present in the range of 0.1 weight percent to 1.5 weight percent of the total weight of the electrolyte including the combination of lithium ion salts, the carbonate solvent, and the vinylene carbonate.

In any of the above embodiments, the electrolyte exhibits an ionic conductivity in the range of 2 millisieverts per centimeter to 12 millisieverts per centimeter at 25 degrees Celsius.

According to various additional aspects, the present disclosure relates to a battery cell for a vehicle. The battery cell includes a cathode electrode including a cathode disposed on a cathode current collector, wherein the cathode includes a cathode active material, an anode electrode including an anode disposed on an anode current collector, wherein the anode includes an anode active material and the anode active material includes silicon, a separator positioned between the cathode and the anode, and an electrolyte contacting the cathode, anode, and separator. In embodiments, the electrolyte includes any of the above electrolytes. In additional or alternative embodiments, the electrolyte includes a combination of lithium ion salts including lithium hexafluorophosphate (LiPF₆), lithium bis(fluorosulfonyl)imide, and lithium difluoro(oxalato)borate, a carbonate solvent including fluoroethylene carbonate, ethyl methyl carbonate, and a carboxylic acid ester exhibiting the following formula:

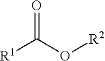

wherein R¹ and R² are individually an unsubstituted alkyl group including in the range of 1 carbon to 2 carbons, wherein the combination of lithium ion salts is dispersed in the carbonate solvent, and vinylene carbonate. The electrolyte does not include ethyl carbonate.

In embodiments of the above, the lithium hexafluorophosphate is present in the carbonate solvent at a concentration (moles (mol) of salt per liter (L) of solvent) of 0.4 mol/L (M) to 1.2 M, the lithium bis(fluorosulfonyl)imide is present in the carbonate solvent at a concentration in the range of 0.1 M to 0.4 M, and the lithium difluoro(oxalato)borate is present in the carbonate solvent at a concentration in the range of 0.05 M to 0.3 M.

In any of the above embodiments, the carboxylic acid ester is at least one of ethyl propionate, methyl acetate, ethyl acetate, and methyl propionate, and wherein the carboxylic acid ester is present in the carbonate solvent in a range of 1 percent by volume to 50 percent of the total volume of the carbonate solvent, the fluoroethylene carbonate is present in the range of 1 percent by volume to 50 percent by volume of the total volume of the carbonate solvent, and the ethyl methyl carbonate is present in the carbonate solvent the range of 10 percent by volume to 90 percent by volume of the total volume of the carbonate solvent.

In any of the above embodiments, the vinylene carbonate is present in the range of 0.1 weight percent to 1.5 weight percent of the total weight of the electrolyte including the lithium ion salt, the carbonate solvent, and the vinylene carbonate.

In any of the above embodiments, the cathode active material includes lithium nickel cobalt manganese aluminum oxide (NCMA) having the formula LiNi_{1-x-y-z}CoₓMn_{y}Al_{z}O₂, wherein x is in the range of 0.1 to 0.7, y is in the range of 0.1 to 0.7, z is in the range of 0.1 to 0.7, and the sum of x, y, and z is 0.9.

In any of the above embodiments, the cathode further includes a conductive additive and a polymer binder, wherein the cathode active material is present in the range of 30 percent by weight to 98 percent by weight of the total weight of the cathode, the conductive additive is present in the range of 0.1 percent by weight to 10 percent by weight of the total weight of the cathode, and the polymer binder is present in the range of 0.1 percent by weight to 10 percent by weight of the total weight of the cathode.

In any of the above embodiments, the anode active material includes at least one of a silicon-carbon composite and silicon oxide having the formula: SiOₓ, wherein x is in the range of 0.1 and 2.

In any of the above embodiments, the anode active material further includes a carbonaceous material including at least one of graphite, hard carbon, and soft carbon.

In further embodiments, the anode active material includes a silicon-carbon composite and graphite, wherein the silicon-carbon composite is present in the range of 5 percent by weight to 99.9 percent by weight of the total weight of the anode active material and graphite is present in the range of 0.1 percent by weight to 95 percent by weight of the total weight of the anode active material.

In any of the above embodiments, the anode further includes a conductive additive and a binder, and the anode active material is present in the range of 30 percent by weight to 98 percent by weight, the conductive additive is present in the range of 0.1 percent by weight to 10 percent by weight, and the binder is present in the range of 0.1 percent by weight to 10 percent by weight.

In any of the above embodiments, the battery cell further includes a solid-electrolyte interface disposed on the anode, wherein lithium oxide is present in the solid-electrolyte interface in the range of 1 percent by weight to 10 percent by weight of the solid electrolyte interface, lithium fluoride is present in the solid-electrolyte interface in the range of 1 percent by weight to 10 percent by weight of the solid electrolyte interface, and a lithiated crosslinked hydrocarbon polymer is present in the solid-electrolyte interface in the range of 2 percent by weight to 30 percent by weight of the solid electrolyte interface, the remainder totaling 100 percent by weight are other organic and inorganic reaction by products of the battery cell components deposited on the anode after formation.

In further embodiments, the lithiated crosslinked hydrocarbon polymer exhibits the following structure:

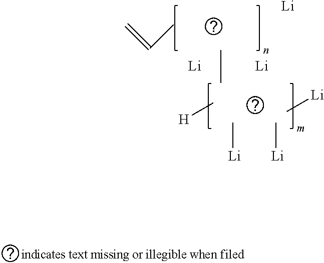

wherein n is in the range of 2 to 200 and m is in the range of 1 to 200.

According to various further aspects, the present disclosure relates to a method of forming a battery cell. The method includes mixing a combination of lithium ion salts with a carbonate solvent and vinylene carbonate to form an electrolyte, wherein the combination of lithium ion salts include lithium hexafluorophosphate (LiPF₆), lithium bis(fluorosulfonyl)imide, and lithium difluoro(oxalato)borate, and the carbonate solvent includes fluoroethylene carbonate, ethyl methyl carbonate, and a carboxylic acid ester exhibiting the following formula:

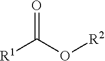

wherein R¹ and R² are individually an unsubstituted alkyl group including in the range of 1 carbon to 2 carbons, and wherein the electrolyte does not include ethyl carbonate, assembling a cathode electrode including a cathode disposed on a cathode current collector, wherein the cathode includes a cathode active material, an anode electrode including an anode disposed on an anode current collector, wherein the anode includes an anode active material and the anode active material includes silicon, and a separator positioned between the cathode and the anode in a battery cell covering. The method further includes introducing the electrolyte into the battery cell covering, wherein the electrolyte contacts the cathode, the anode, and the separator and does not include ethyl carbonate.

In embodiments, the method further includes charging the battery cell under pressure in the range of 0.1 megapascals to 2 megapascals at an elevated temperature in the range of 45 degrees Celsius to 80 degrees Celsius and forming a solid-electrolyte interface on the anode, wherein lithium oxide present is in the range of 1 percent by weight to 10 percent by weight of the solid electrolyte interface, lithium fluoride present in the range of 1 percent by weight to 10 percent by weight of the solid electrolyte interface, and a lithiated crosslinked hydrocarbon polymer is present in the range of 2 percent by weight to 30 percent by weight of the solid electrolyte interface.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates an exploded view of the layers of a battery cell according to embodiments of the present disclosure.

FIG. 2B illustrates a pouch or prismatic battery cell according to embodiments of the present disclosure.

FIG. 3 illustrates a method of forming a battery cell according to embodiments of the present disclosure.

FIG. 4 is a graph of percentage capacity retention (y-axis) as a function of charge and discharge cycle number (x-axis) at 25 degrees Celsius and a charge rate and discharge rate of 1C (1 hour).

FIG. 5 is a graph of percentage capacity retention (y-axis) as a function of charge and discharge cycle number (a-axis) at 45 degrees Celsius and a charge rate and discharge rate of 1C (1 hour).

FIG. 6 is a graph of the effect of change in temperature in degrees Celsius (primary, left y-axis) on voltage in volts (secondary, right y-axis) relative to exposure time in hours (x-axis).

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to an electrolyte, a battery cell for a vehicle including the electrolyte, a battery for a vehicle, and a method of forming the electrolyte and battery cell. The electrolyte can be used in a number of battery cell platforms including prismatic or pouch style battery cells. The electrolyte and battery cell can be used in batteries for electric or hybrid-electric vehicles. The electrolyte includes a combination of a carboxylic acid ester such as ethyl propionate, fluoroethylene carbonate, and ethyl methyl carbonate in the carbonate solvent.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

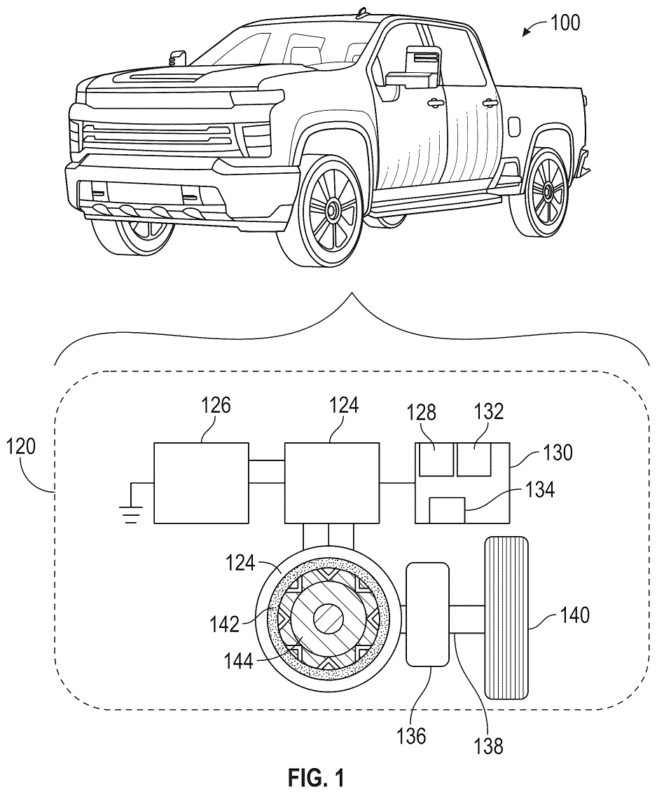

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field (as caused by physical rotation) of the rotor 144 generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

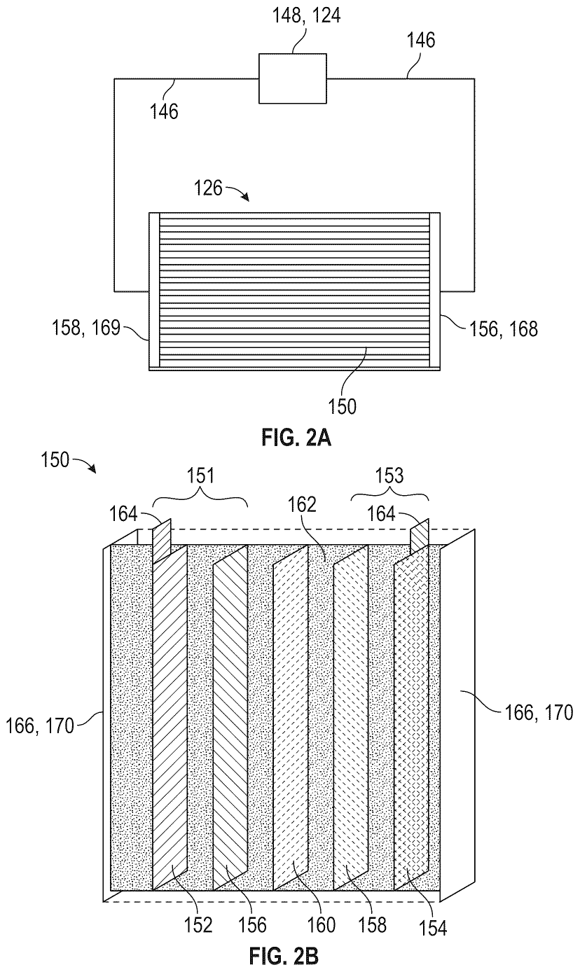

Reference is made to FIGS. 2A and 2B illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. As illustrated in FIG. 2A, a battery 126 is connected to a load 148, such as the electric motor 124. However, other loads 148 include various systems in the vehicle 100 such as climate control systems and infotainment systems. The battery 126 includes one or more battery cells 150 assembled together. The battery cells 150 may be, for example, a pouch style or a prismatic style battery cell, which are discussed further below. With reference again to FIGS. 2A and 2B, when a load 148 is applied to the battery 126, Li+ ions move from the anode 158 to the cathode 156 through the separator 160 by way of the electrolyte 162. Equivalent electrons e− move through the circuitry 146 from the cathode 156 to the anode 158, providing voltage to the load 148. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIG. 2B, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode 156 (and one cathode current collector 152), the battery cell 150 may alternatively include two or more cathodes 156 (and one or more cathode current collectors 152) and one or more anodes 158 (and one or more anode current collectors 154). In further alternative embodiments, the battery cell 150 may include or one or more cathodes 156 (and one or more cathode current collectors 152) and two or more anodes 158 (and two or more anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154. Alternatively, the tabs 164 are formed integrally with the cathode current collectors 152 and anode current collectors 154 by cutting the tabs 164 with the cathode current collectors 152 and anode current collectors 154 from larger sheet stock. In addition, the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In the various styles of battery cells 150 noted above, the cathode current collector 152 and anode current collector 154 are formed from conductive materials. In embodiments, the cathode current collector 152 includes aluminum. Alternatively, or additionally, the cathode current collector 152 may include stainless steel. In embodiments, the anode current collector 154 includes copper. Alternatively or additionally, the anode current collector 154 may include nickel, stainless steel, and titanium. The current collectors 152, 154 are illustrated as being in the form of a foil; however, it should be appreciated that other forms may be exhibited such as mesh. In embodiments, a foil cathode current collector 152 and a foil anode current collector 154 are impermeable to gas. The cathode current collector 152 exhibits a thickness in the range of 2 micrometers to 50 micrometers, including all values and ranges therein, such as in the range of 5 micrometers to 25 micrometers. The anode current collector 154 exhibits a thickness in the range of 2 micrometers to 50 micrometers, including all values and ranges therein, such as in the range of 4 micrometers to 25 micrometers.

The cathode 156 includes a source of lithium ions (Li⁺) and can undergo reversible insertion or intercalation of lithium ions, determining e.g., the capacity and average voltage of a battery, referred to as a cathode active material. In embodiments, the cathode active material includes at least one of lithium cobalt oxide (LiCoO₂), which may be referred to as a rock salt layered oxide; lithium- and manganese-rich material having the formulation xLi₂MnO₃-(1-x)LiMO₂, where “M” is at least one of nickel, cobalt, and manganese, and “x” is a fraction indicating the relative proportion of the Li₂MnO₃ phase within the structure and is in the range of 0 to 1; lithium nickel manganese cobalt oxides having the formula LiNiₐMn_{b}CO_{c}O₂, wherein the sum of a, b, and c is 1 such as a LiNi_{0.33}Mn_{0.33}Co_{0.33}O₂ (NMC 111), LiNi_{0.5}Mn_{0.3}Co_{0.2}O₂ (NMC 523), LiNi_{0.6}Mn_{0.2}Co_{0.2}O₂ (NMC 622), LiNi_{0.7}Mn_{0.2}Co_{0.1}O₂ (NMC 721), LiNi_{0.75}Mn_{0.25}O₂ (NM 75), and LiNi_{0.8}Mn_{0.1}Co_{0.1}O₂ (NMC 811), which may also be referred to as rock salt layered oxides; lithium nickel manganese aluminum oxide having the formula LiNiₓMn_{y}Al_{1-x-y}O₂, wherein x is in the range of 0.1 to 0.8, y is in the range of 0.1 to 0.8 and the sum of x and y is 0.9, which may also be referred to as rock salt layered oxides; lithium nickel manganese oxide having the formula LiNiₓMn₁₋ₓO₂ wherein x is in the range of 0.1 to 0.9, which may also be referred to as rock salt layered oxides; lithium nickel cobalt manganese aluminum oxide (NCMA) having the formula LiNi_{1-x-y-z}CoₓMn_{y}Al_{z}O₂, wherein x is in the range of 0.1 to 0.7, y is in the range of 0.1 to 0.7, z is in the range of 0.1 to 0.7, and the sum of x, y, and z is 0.9; spinel lithium manganese oxide (LiMn₂O₄); spinel lithium nickel manganese oxide (LiNi_{0.5}Mn_{1.5}O₄); lithium vanadium phosphate LiV₂(PO₄)₃ polyanion material; olivine lithium iron phosphate (LiFePO₄); and olivine lithium manganese iron phosphate having the formula LiMnₓFe₁₋ₓPO₄ wherein x is in the range of 0.1 to 0.9 and other lithium transition metal oxides. Additionally or alternatively, the cathode active material includes any of the above cathode active materials surface coated with at least one of LiNbO₃, Li₂ZrO₃, and Li₃PO₄, such as LiNbO₃-coated LiMn₂O₄, Li₂ZrO₃ coated lithium nickel manganese cobalt oxide, LiPO₄ coated lithium nickel manganese cobalt oxide. Additionally or alternatively to the cathode active materials noted above, the cathode active material includes any of the above cathode active materials surface doped with aluminum (Al) such as Al-doped lithium manganese oxide. Additionally or alternatively to the cathode active materials noted above, the cathode active material may also include low-voltage materials such as at least one of lithiated metal sulfide (LiTiS₂), lithium sulfide (Li₂S), and sulfur (S).

In embodiments of the above, the cathode further includes a conductive additive. The conductive additive includes at least one of carbon black, graphite, graphene, graphene oxide, conductive carbon black powder such as SUPER P Li available from IMERYS, acetylene black, carbon nanofibers, carbon nanotubes. In embodiments, the conductive additive includes one or more conductive additives selected from the group consisting of the above conductive additives. Additionally, or alternatively, other electronically conductive additives may be present including one or more of polyaniline, polypyrrole, poly(3,4-ethylenedioxythiophene), and polythiophene nanofibers.

In further embodiments of the above, the cathode includes a binder. The binder includes one or more polymers. In embodiments the polymer includes at least one of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co-hexafluoropropylene) (PVDF-HFP), polyethylene oxide (PEO), polyacrylonitrile (PAN), poly(acrylic acid) (PAA), and styrene butadiene styrene copolymer (SBS). In embodiments, the polymer binder includes one or more binders selected from the group consisting of the above binders. Additionally, or alternatively, other binders may be present.

In embodiments, the cathode includes the cathode active material present in the range of 30 percent by weight to 98 percent by weight of the total weight percent of the cathode, including all values and ranges therein. If present, the conductive additive is present in the range of 0.1 percent by weight to 10 percent by weight of the total percent weight of the cathode, including all values and ranges therein. Alternatively, in embodiments, no conductive additives are present. If present, the binder is present in the range of 0.1 percent by weight to 10 percent by weight of the total weight percent of the cathode, including all values and ranges therein. Alternatively, in embodiments, no binder present. The total weight percent of the cathode is 100 weight percent.

In embodiments the cathode is deposited on the cathode current collector by way of wet-coat processing, dry-film processing, dry-powder processing, etc. In wet-coat processing the cathode materials, i.e., the cathode active material and if present the conductive additive and binder, are mixed into a dispersion medium, which may also be a binder solvent. In embodiments, the dispersion medium includes, in embodiments, n-methyl-2-pyrrolidone (NMP), dimethylformamide (DMF), p-xylene, ethanol, and toluene. The cathode materials are then applied in dispersion onto the cathode current collector and the solvent is driven off. In dry-film processing the cathode materials are mixed, kneaded, and calendared onto the cathode current collector. In dry-powder processing, the cathode materials are mixed and then applied to the to the cathode current collector using pressure and heat.

In embodiments, the cathode is deposited on the cathode current collector 152 at a density in the range of 1.0 milliamp-hours per square centimeter to 10 milliamp-hours per square centimeter, including all values and ranges therein, such as from 1.7 milliamp-hours per square centimeter to 4.5 milliamp-hours per square centimeter. The cathode material includes particles that exhibit a particle size (largest linear cross-section as measured by optical microscopy) of in the range of 5 nanometers to 50 micrometers including all values and ranges therein.

The cathode electrode 151, including both the cathode current collector 152 and the cathode 156, exhibits a thickness in the range of 10 micrometers to 500 micrometers including all values and ranges therein when the cathode material is formed on one side of the cathode current collector 152. When the cathode material is formed on both sides of the cathode current collector 152, the cathode electrode exhibits a thickness in the range of 25 micrometers to 1050 micrometers including all values and ranges therein for a double sided cathode electrode, such as in the range of 100 micrometers to 500 micrometers.

The anode 158 includes an anode active material that can undergo reversible insertion or intercalation of lithium ions at a lower electrochemical potential than the cathode 156, such that an electrochemical potential difference exists between the anode 158 and cathode 156. The anode active material includes silicon. In embodiments, the silicon is pure silicon, including at least 99.9 percent by weight of the total weight of the silicon. Further, the silicon may exhibit one of a number of morphologies, including, but not limited to, octahedral and twinned spinel as well as spherical. Alternatively, the anode active material includes silicon element and at least one of carbon and oxygen elements. In embodiments including carbon, the anode active material includes a silicon-carbon composite including 20 percent to 80 percent by weight silicon in the silicon-carbon composite, wherein the remainder includes carbon and the total weight percent of the silicon-carbon composite is 100 weight percent. In embodiments including oxygen, the anode active material includes silicon oxide (SiOₓ, wherein x is present in the range of 0.1 to 2).

In further embodiments, any of the above anode active materials further include a carbonaceous material including at least one of graphite, hard carbon (also referred to as non-graphitizing carbon or char), and soft carbon (also referred to as graphitizing carbon). For the anode active material at least one of the silicon, silicon oxide, and silicon-carbon composite are present in the range of 5 percent by weight to 99 percent by weight of the total weight of the anode active material and the carbonaceous material is present in the range of 0.1 percent by weight to 98 percent by weight of the total weight of the anode active material, and the total weight percent of the anode active material is 100 weight percent. In alternative embodiments, the anode active material includes a carbonaceous material including at least one of graphite, hard carbon (also referred to as non-graphitizing carbon or char) and soft carbon (also referred to as graphitizing carbon).

In embodiments, the anode also includes a conductive additive. The conductive additive includes at least one of carbon black, graphite, graphene, graphene oxide, Super P, acetylene black, carbon nanofibers, carbon nanotubes. In embodiments, the conductive additive includes one or more conductive additives selected from the group consisting of the above conductive additives. Additionally, or alternatively, other electronically conductive additives may be present including one or more of polyaniline, polypyrrole, poly(3,4-ethylenedioxythiophene), and polythiophene nanofibers.

In embodiments, the anode further includes a binder. The binder includes a polymer material including at least one of polytetrafluoroethylene (PTFE), sodium carboxymethyl cellulose (CMC), styrene-butadiene rubber (SBR), poly(vinylidene fluoride) (PVDF), nitrile butadiene rubber (NBR), hydrogenated nitrile butadiene styrene rubber (HNBR), styrene ethylene butylene styrene copolymer (SEBS), poly(vinylidene fluoride-co-hexafluoropropylene) (PVDF-HFP), polyethylene oxide (PEO), polyacrylonitrile (PAN), poly(acrylic acid) (PAA), and styrene butadiene styrene copolymer (SBS). In embodiments, the polymer binder includes one or more binders selected from the group consisting of the above binders. Additionally, or alternatively, other binders may be present.

In any of the above embodiments, the anode may be doped with at least one of lithium and magnesium.

In embodiments, the anode includes the anode active material present in the range of 30 percent by weight to 98 percent by weight of the total weight percent of the anode, including all values and ranges therein. If present, the conductive additive is present in the range of 0.1 percent by weight to 10 percent by weight of the total percent weight of the anode, including all values and ranges therein. Alternatively, in embodiments, no conductive additives are present. If present, the polymer binder is present in the range of 0.1 percent by weight to 10 percent by weight of the total weight percent of the anode, including all values and ranges therein. Alternatively, in embodiments, no binder present. The total weight percent of the anode is 100 weight percent.

In embodiments the anode is deposited on the anode current collector by way of wet-coat processing, dry-film processing, dry-powder processing, etc. In wet-coat processing the anode materials, i.e., the anode active material and if present the conductive additive and binder, are mixed into a dispersion medium, which may also be a binder solvent. In embodiments, the dispersion medium includes, in embodiments, n-methyl-2-pyrrolidone (NMP), dimethylformamide (DMF), p-Xylene, ethanol, and toluene. The anode materials are then applied in dispersion onto the anode current collector and the solvent is driven off. In dry-film processing the anode materials are mixed, kneaded, and calendared onto the anode current collector. In dry-powder processing, the anode materials are mixed and then applied to the to the anode current collector using pressure and heat.

In embodiments, the anode material is deposited on the anode current collector 154 at a density in the range of 1.0 milliamp-hours per square centimeter to 10 milliamp-hours per square centimeter, including all values and ranges therein such as from 1.87 milliamp-hours per square centimeter to 8 milliamp-hours per square centimeter. Further, the press density, density after pressing, of the anode material is in the range of 0.8 grams per cubic centimeter to 2 grams per cubic centimeter, including all values and ranges therein, such as from 1.5 grams per cubic centimeter to 1.7 grams per cubic centimeter.

In embodiments, the anode 158 exhibits a thickness in the range of 10 micrometers to 550 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 includes at least one of the following polymer materials: polyethylene, polypropylene, cellulose, polyamide, polytetrafluoroethylene, polyvinylidene fluoride, polyvinylidene fluoride-hexapolypropylene, polyvinyl chloride, polyimide, polyetherimide, polyimide bisphenol-acetone diphthalic anhydride and para-phenylenediamine (BPADA-m-PDA), and polymaleimide. In embodiments, the separator is coated with at least one of a ceramic, such as silicon oxide (SiO₂) or aluminum oxide (Al₂O₃), and another polymer such as poly(lithium 4-styrenesulfonate) and co-polyimides. Ceramic coated separators include, for example, SiO₂ coated polyethylene. Polymer coated separators include, for example, copolyimide coated polyethylene. Ceramic and polymer coated separators include nano-sized Al2O3 and poly(lithium 4-styrenesulfonate) coated polyethylene. In further embodiments, the separator includes a composite of any of the above mentioned compositions, such as a two layer composite of polypropylene and polyethylene, a three-layer composite of polyethylene sandwiched between polypropylene layers, expanded polytetrafluoroethylene with polyvinylidenefluoride-hexafluoropropylene formed on one or both sides of the expanded polytetrafluoroethylene, and a three-layer composite of polymaleimide sandwiched between layers of polyvinylidene fluoride. In embodiments, the individual separator layers are formed from at least one of porous film, mesh, woven fibers, and non-woven nanofibers. The separator exhibits a porosity, the void volume present in the volume defined by the separator, in the range of 20 percent by volume to 60 percent by volume of the total volume defined by the separator, including all values and ranges therein. In embodiments, the separator 160 exhibits a thickness in the range of 4 micrometers to 25 micrometers, including all values and ranges therein.

The electrolyte 162 provides a medium between the cathode 156 and anode 158 through which lithium ions travel. The electrolyte 162 is a liquid electrolyte that permeates the separator 160, contacts the surfaces of the cathode 156 and anode 158, and flows into interstices that may be present between the particles forming the cathode 156 and the anode 158. In embodiments, in the range of 50 percent to 150 percent of the total porous volume of the separator 160 is wet by the electrolyte. The electrolyte includes a combination of lithium ion salts, a carbonate solvent, and an additive. In embodiments, the electrolyte 162 does not include ethyl carbonate.

The combination of lithium ion salts includes lithium hexafluorophosphate (LiPF₆), lithium bis(fluorosulfonyl)imide, and lithium difluoro(oxalato)borate. The lithium hexafluorophosphate is present in the carbonate solvent at a concentration (moles (mol) of salt per liter (L) of solvent) of 0.4 mol/L (M) to 1.2 M, including all values and ranges therein, such as 0.8 M. The lithium bis(fluorosulfonyl)imide is present in the carbonate solvent at a concentration in the range of 0.1 M to 0.4 M, including all values and ranges therein, such as 0.2 M. The lithium difluoro(oxalato)borate is present in the carbonate solvent at a concentration in the range of 0.05 M to 0.3 M, including all values and ranges therein, such as 0.1 M.

The lithium ion salts are dispersed in a carbonate solvent. The carbonate solvent includes a combination of a carboxylic acid ester, fluoroethylene carbonate, and ethyl methyl carbonate. In embodiments, the carboxylic acid ester exhibits the following formula:

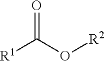

wherein R¹ and R² are individually an unsubstituted alkyl group including in the range of 1 to 2 carbons. In embodiments, the carboxylic acid ester is ethyl propionate. Additionally or alternatively, the carboxylic acid ester includes at least one of methyl acetate, ethyl acetate and methyl propionate. The carboxylic acid ester is present in the carbonate solvent in a range of 1 percent by volume to 50 percent of the total volume of the carbonate solvent. The fluoroethylene carbonate is present in the range of 1 percent by volume to 50 percent by volume of the total volume of the carbonate solvent. The ethyl methyl carbonate is present in the carbonate solvent the range of 10 percent by volume to 90 percent by volume of the total volume of the carbonate solvent. The total volume percent of the carbonate solvent is 100 percent.

The electrolyte additive includes vinylene carbonate. The additive is present in the range of 0.1 weight percent to 1.5 weight percent of the total weight of the electrolyte including the lithium ion salt, the carbonate solvent, and the additive, wherein total weight percent is 100 weight percent and the lithium ion salt and the carbonate solvent is the remainder of the total weight percent.

In embodiments, the ionic conductivity of the electrolyte 162 is in the range of 2 millisieverts per centimeter to 12 millisieverts per centimeter, including all values and ranges therein such as 8.7 millisieverts per centimeter, measured at 25 degrees Celsius. The ionic conductivity is measured via alternating current impedance measurement.

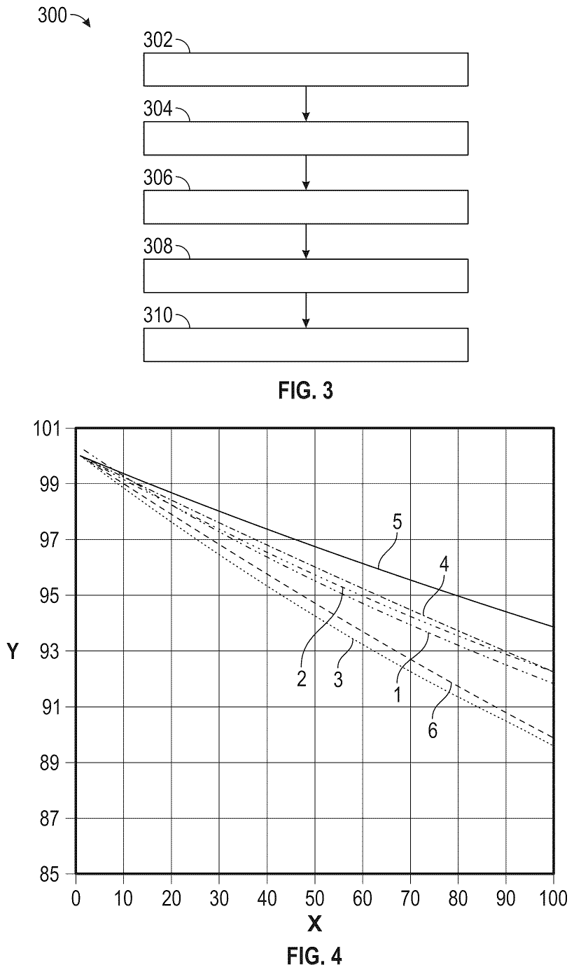

The electrolyte 162 is formed by mixing the lithium ion salt with the carbonate solvent and the additives. The electrolyte 162 may then be added to a battery cell 150 as illustrated in FIG. 2B. FIG. 3 illustrates an embodiment of a method 300 of forming a battery cell 150 including the electrolyte 162. At block 302, the cathode current collector 152 with the cathode 156, the anode current collector 154 with the anode 158, and the separator 160 are assembled in a battery cell 150 covering 166. In embodiments, the cathode 156 is deposited onto the cathode current collector 152 prior to battery cell 150 assembly and the anode 158 is deposited onto the anode current collector 154 prior to battery cell assembly 150. At block 304, the electrolyte 162 is added to the battery cell 150. At block 306 the battery cell 150 is pre-sealed.

At block 308 the battery cell 150 is coupled to a circuit and undergoes hot-press formation. That is, current is applied to the battery cell 150 for the first time while the battery cell is exposed to elevated temperatures and pressure. The battery cell 150 is charged at a rate in the range of 0.5 hours to 10 hours to charge and then degassed to remove the gas generated in the formation. At block 310, the battery cell undergoes a final seal. The pressure applied to the battery cell 150 during formation is in the range of 0.1 megapascals (MPa) to 2 megapascals (MPa), including all values and ranges therein, such as 1 MPa, is applied to the primary surfaces 170 of the battery cell 150 casing 166. In addition, battery formation occurs at temperatures of 45 degrees Celsius or greater, such as in the range of from 45 degrees Celsius to 80 degrees Celsius.

During hot press formation of a battery cell 150 various chemical reactions occur in the battery cell 150 causing solid-electrolyte interface form on the anode, cathode electrolyte interface form on the cathode, and structural changes occur to the cathode and anode materials. In embodiments, a mixed organic and inorganic solid-electrolyte interface forms on the anode 158 in the battery cell 150. During hot-press formation in situ polymerization occurs forming a lithiated crosslinked hydrocarbon polymer in the solid electrolyte interface formed on the anode 158. In further embodiments, the polymer exhibits the following structure, Str. 1.

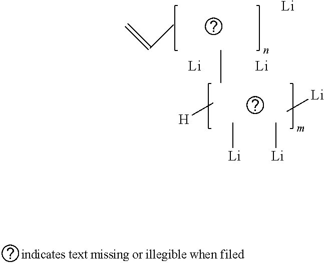

In the above structure, n is in the range of 2 to 200 and m is in the range of 1 to 200. In embodiments, the cross-linked polymer content of the solid-electrolyte interface is in the range of 2 percent by weight to 30 percent by weight of the total weight of the solid-electrolyte interface, including all values and ranges therein. In addition to cross-linked polymer phases, the solid electrolyte interface includes lithium compounds such as lithium fluoride (LiF) and lithium oxide (Li₂O). In embodiments, the lithium fluoride is present in the range of 1 percent by weight to 10 percent by weight of the total weight of the solid-electrolyte interface, including all values and ranges therein. Further, the lithium oxide is present in the range of 1 percent by weight to 10 percent by weight of the total weight of the solid-electrolyte interface, including all values and ranges therein. The remainder, totaling 100 percent by weight of the solid-electrolyte interface, includes other organic and inorganic compounds that are reaction products of the components of the battery cell 150 and deposited on the anode that are formed upon the application of the charge, elevated temperature, and pressure on the battery cell 150.

### EXAMPLES

The following examples are not meant to limit the scope of the disclosure but are provided herein for illustrative purposes.

Various electrolytes were prepared and added into 1 amp-hour pouch battery cells. The cathode material included lithium nickel cobalt manganese aluminum oxide (NCMA) and the anode included 50 percent by weight silicon-carbon and 50 percent by weight graphite. The NCMA cathode included NCMA present at 95 percent by weight of the total weight of the cathode, carbon black present at 2.9 percent by weight of the total weight of the cathode, single wall carbon nanotubes present at 0.1 percent by weight of the total weight of the cathode, and polyvinylidene fluoride present at 2 percent by weight of the total weight of the cathode. The anode included graphite present at 47.6 percent by weight of the total weight of the anode, silicon-carbon compound present at 47.6 percent by weight of the total weight of the anode, carbon black present at 0.5 percent by weight of the total weight of the anode, single wall carbon nanotubes present at 0.1 percent by weight of the total weight of the anode, sodium carboxymethyl cellulose present at 1.2 percent by weight of the total weigh of the anode, and styrene butadiene rubber present at 3.0 percent by weight of the total weight of the anode. The cathode current collector included aluminum foil of 12 um in thickness and the anode current collector included copper foil of 10 um in thickness. The electrolytes all included lithium iron phosphate (LiPF6) present in the carbonate solvent at concentration of 0.8M, lithium bis(fluorosulfonyl)imide (LiFSI) present in the carbonate solvent at concentration of 0.2M, and lithium difluorooxalatoborate (LiODFB) present in the carbonate solvent at concentration of 0.1M. The ionic conductivity of the electrolytes were measured at 25 degrees Celsius. The electrolyte compositions and ionic conductivity are present in Table 1 below.

TABLE 1
Electrolyte and Ionic Conductivity

| | | | | | | | Weight | |
|---|---|---|---|---|---|---|---|---|
| | | | | | | | Percent (wt %) | |
| | | | | | | | of the total | Ionic |
| | | | | | | | weight of the | Conductivity |
| Formulation | Volume Ratio V/V(%) | | | | | | electrolyte | (milliSieverts/ |
| No. | EC | FEC | EMC | EP | DFEA | PC | VC | centimeter) |
| 1 | 20 | 10 | 70 | | | | 0.50 | 8.75 |
| 2 | 10 | 20 | 70 | | | | 0.50 | 8.55 |
| 3 | | 30 | 70 | | | | 0.50 | 8.31 |
| 4 | | 20 | 60 | | | 20 | 0.50 | 8.40 |
| 5 | | 20 | 60 | 20 | | | 0.50 | 8.66 |
| 6 | | 20 | 60 | | 20 | | 0.50 | 7.77 |

Wherein EC is ethyl carbonate, FEC is fluoroethylene carbonate, EMC is ethyl methyl carbonate, EP is ethyl propionate, DFEA is 2,2-difluoroethyl acetate, and PC is propylene carbonate. As illustrated in the table above, the ionic conductivity of the formulation including ethyl propionate exhibited ionic conductivity in the range of formulations including ethyl carbonate.

Pouch cells were created as described above including the above electrolyte formulations were cycled, i.e., charged and discharged, at 25 degrees Celsius using a charging rate of 1C (1 hour from 0 percent charge to maximum charge) and a discharge rate of 1C (1 hour from maximum charge to maximum discharge). The pouch cell was cycled at least 100 times. As illustrated, in FIG. 4 (each formulation being identified by number in the graph), the formulation including the ethyl propionate exhibited the highest percentage capacity retention (y-axis) over 100 cycles (x-axis).

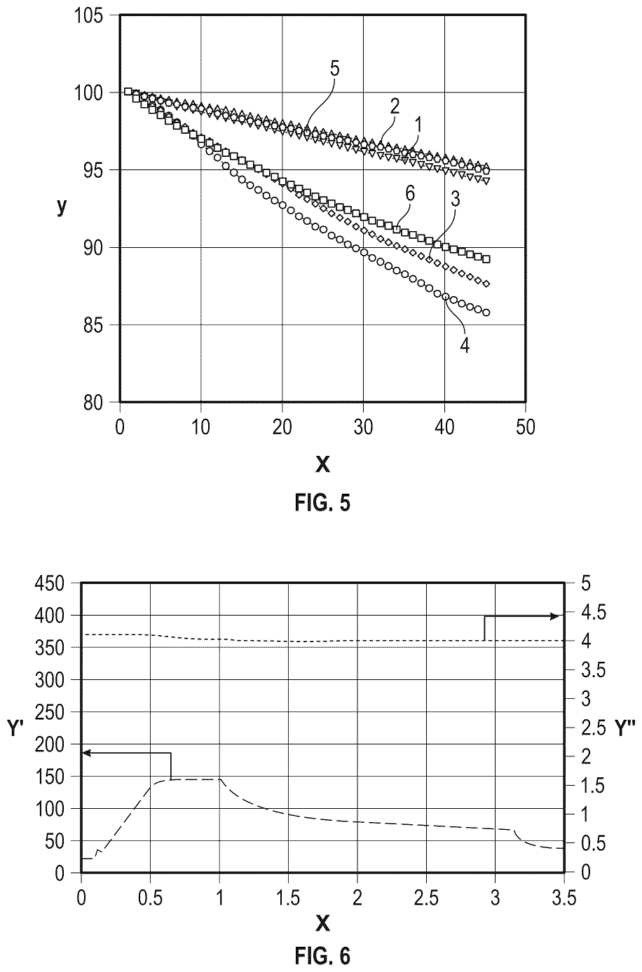

Pouch cells were created as described above including the above electrolyte formulations were cycled, i.e., charged and discharged, at 45 degrees Celsius using a charging rate of 1C (1 hour from 0 percent charge to maximum charge) and a discharge rate of 1C (1 hour from maximum charge to maximum discharge). The pouch cell was cycled at least 100 times. As illustrated, in FIG. 5 (each formulation being identified by number in the graph), the formulation including the ethyl propionate exhibited the one of the higher percentage capacity retention (y-axis) over 100 cycles (x-axis).

A pouch cell was created as described above including electrolyte formulation number 5. As illustrated in FIG. 6, the pouch cell was exposed to elevated temperatures in the range of 25 degrees Celsius to 150 degrees Celsius (primary, left y′-axis) over 3.5 hours (horizontal, x-axis). The voltage measured in volts (secondary, right y″-axis) decreased little over the increase in temperature and remained above 4 volts.

The electrolytes, battery cells, secondary batteries, and methods of making described herein offer a number of advantages. These advantages include, for example, the formation of a mixed organic and inorganic solid-electrolyte interface. The organic phase including a cross-linked polymer that may increase lithium ion conductivity and at least partially accommodate silicon anode volume expansion. The inorganic phase includes lithium fluoride and lithium oxide which enable the solid-electrolyte interface shell to remain stable during larger silicone anode volume changes. Further advantages include increased stability in battery cell cycling. Yet further advantages include increased thermal stability for battery cells including silicon or silicon-carbon anodes over the use of ethyl carbonate in the carbonate solvent.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electrolyte for a battery cell, the electrolyte comprising:
a combination of lithium ion salts including lithium hexafluorophosphate (LiPF₆), lithium bis(fluorosulfonyl)imide, and lithium difluoro(oxalato)borate;
a carbonate solvent including fluoroethylene carbonate, ethyl methyl carbonate, and a carboxylic acid ester exhibiting the following formula: 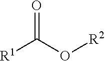
wherein R¹ and R² are individually an unsubstituted alkyl group including in the range of 1 carbon to 2 carbons, wherein the combination of lithium ion salts is dispersed in the carbonate solvent; and
vinylene carbonate,
wherein the electrolyte does not include ethyl carbonate.

2. The electrolyte of claim 1, wherein the lithium hexafluorophosphate is present in the carbonate solvent at a concentration (moles (mol) of salt per liter (L) of solvent) of 0.4 mol/L (M) to 1.2 M, the lithium bis(fluorosulfonyl)imide is present in the carbonate solvent at a concentration in the range of 0.1 M to 0.4 M, and the lithium difluoro(oxalato)borate is present in the carbonate solvent at a concentration in the range of 0.05 M to 0.3 M.

3. The electrolyte of claim 1, wherein the carboxylic acid ester is at least one of ethyl propionate, methyl acetate, ethyl acetate, and methyl propionate.

4. The electrolyte of claim 3, wherein the carboxylic acid ester is present in the carbonate solvent in a range of 1 percent by volume to 50 percent of the total volume of the carbonate solvent, the fluoroethylene carbonate is present in the range of 1 percent by volume to 50 percent by volume of the total volume of the carbonate solvent, and the ethyl methyl carbonate is present in the carbonate solvent the range of 10 percent by volume to 90 percent by volume of the total volume of the carbonate solvent.

5. The electrolyte of claim 1, wherein the vinylene carbonate is present in the range of 0.1 weight percent to 1.5 weight percent of the total weight of the electrolyte including the combination of lithium ion salts, the carbonate solvent, and the vinylene carbonate.

6. The electrolyte of claim 1, wherein the electrolyte exhibits an ionic conductivity in the range of 2 millisieverts per centimeter to 12 millisieverts per centimeter at 25 degrees Celsius.

7. A battery cell for a vehicle, comprising:
a cathode electrode including a cathode disposed on a cathode current collector, wherein the cathode includes a cathode active material;
an anode electrode including an anode disposed on an anode current collector, wherein the anode includes an anode active material and the anode active material includes silicon;
a separator positioned between the cathode and the anode; and
an electrolyte contacting the cathode, anode, and separator, wherein the electrolyte includes:
a combination of lithium ion salts including lithium hexafluorophosphate (LiPF₆), lithium bis(fluorosulfonyl)imide, and lithium difluoro(oxalato)borate;
a carbonate solvent including fluoroethylene carbonate, ethyl methyl carbonate, and a carboxylic acid ester exhibiting the following formula: 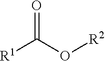
wherein R¹ and R² are individually an unsubstituted alkyl group including in the range of 1 carbon to 2 carbons, wherein the combination of lithium ion salts is dispersed in the carbonate solvent; and
vinylene carbonate,
wherein the electrolyte does not include ethyl carbonate.

8. The battery cell of claim 7, wherein the lithium hexafluorophosphate is present in the carbonate solvent at a concentration (moles (mol) of salt per liter (L) of solvent) of 0.4 mol/L (M) to 1.2 M, the lithium bis(fluorosulfonyl)imide is present in the carbonate solvent at a concentration in the range of 0.1 M to 0.4 M, and the lithium difluoro(oxalato)borate is present in the carbonate solvent at a concentration in the range of 0.05 M to 0.3 M.

9. The battery cell of claim 7, wherein the carboxylic acid ester is at least one of ethyl propionate, methyl acetate, ethyl acetate, and methyl propionate, and wherein the carboxylic acid ester is present in the carbonate solvent in a range of 1 percent by volume to 50 percent of the total volume of the carbonate solvent, the fluoroethylene carbonate is present in the range of 1 percent by volume to 50 percent by volume of the total volume of the carbonate solvent, and the ethyl methyl carbonate is present in the carbonate solvent the range of 10 percent by volume to 90 percent by volume of the total volume of the carbonate solvent.

10. The battery cell of claim 7, wherein the vinylene carbonate is present in the range of 0.1 weight percent to 1.5 weight percent of the total weight of the electrolyte including the lithium ion salts, the carbonate solvent, and the vinylene carbonate.

11. The battery cell of claim 7, wherein the cathode active material includes lithium nickel cobalt manganese aluminum oxide (NCMA) having the formula LiNi_{1-x-y-z}CoₓMn_{y}Al_{z}O₂, wherein x is in the range of 0.1 to 0.7, y is in the range of 0.1 to 0.7, z is in the range of 0.1 to 0.7, and the sum of x, y, and z is 0.9.

12. The battery cell of claim 7, wherein the cathode further includes a conductive additive and a polymer binder, wherein the cathode active material is present in the range of 30 percent by weight to 98 percent by weight of the total weight of the cathode, the conductive additive is present in the range of 0.1 percent by weight to 10 percent by weight of the total weight of the cathode, and the polymer binder is present in the range of 0.1 percent by weight to 10 percent by weight of the total weight of the cathode.

13. The battery cell of claim 7, wherein the anode active material includes at least one of a silicon-carbon composite and silicon oxide having the formula: SiOₓ, wherein x is in the range of 0.1 and 2.

14. The battery cell of claim 7, wherein the anode active material further includes a carbonaceous material including at least one of graphite, hard carbon, and soft carbon.

15. The battery cell of claim 14, wherein the anode active material comprises a silicon-carbon composite and graphite, wherein the silicon-carbon composite is present in the range of 5 percent by weight to 99.9 percent by weight of the total weight of the anode active material and graphite is present in the range of 0.1 percent by weight to 95 percent by weight of the total weight of the anode active material.

16. The battery cell of claim 7, wherein the anode further includes a conductive additive and a binder, and the anode active material is present in the range of 30 percent by weight to 98 percent by weight, the conductive additive is present in the range of 0.1 percent by weight to 10 percent by weight, and the binder is present in the range of 0.1 percent by weight to 10 percent by weight.

17. The battery cell of claim 7, further comprising a solid-electrolyte interface disposed on the anode, wherein lithium oxide is present in the solid-electrolyte interface in the range of 1 percent by weight to 10 percent by weight of the solid electrolyte interface, lithium fluoride is present in the solid-electrolyte interface in the range of 1 percent by weight to 10 percent by weight of the solid electrolyte interface, and a lithiated crosslinked hydrocarbon polymer is present in the solid-electrolyte interface in the range of 2 percent by weight to 30 percent by weight of the solid electrolyte interface, the remainder totaling 100 percent by weight are other organic and inorganic reaction by-products deposited on the anode after formation.

18. The battery cell of claim 17, wherein the lithiated crosslinked hydrocarbon polymer exhibits the following structure: 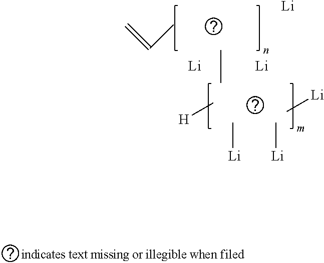
wherein n is in the range of 2 to 200 and m is in the range of 1 to 200.

19. A method of forming a battery cell, comprising:
mixing a combination of lithium ion salts with a carbonate solvent and vinylene carbonate to form an electrolyte, wherein the combination of lithium ion salts include lithium hexafluorophosphate (LiPF₆), lithium bis(fluorosulfonyl)imide, and lithium difluoro(oxalato)borate, and the carbonate solvent includes fluoroethylene carbonate, ethyl methyl carbonate, and a carboxylic acid ester exhibiting the following formula: 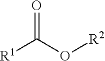
wherein R¹ and R² are individually an unsubstituted alkyl group including in the range of 1 carbon to 2 carbons, and wherein the electrolyte does not include ethyl carbonate;
assembling a cathode electrode including a cathode disposed on a cathode current collector, wherein the cathode includes a cathode active material, an anode electrode including an anode disposed on an anode current collector, wherein the anode includes an anode active material and the anode active material includes silicon, and a separator positioned between the cathode and the anode in a battery cell covering; and
introducing the electrolyte into the battery cell covering, wherein the electrolyte contacts the cathode, the anode, and the separator, and does not include ethyl carbonate.

20. The method of claim 19, further comprising charging the battery cell under pressure in the range of 0.1 megapascals to 2 megapascals at an elevated temperature in the range of 45 degrees Celsius to 80 degrees Celsius and forming a solid-electrolyte interface on the anode, wherein lithium oxide present is in the range of 1 percent by weight to 10 percent by weight of the solid electrolyte interface, lithium fluoride present in the range of 1 percent by weight to 10 percent by weight of the solid electrolyte interface, and a lithiated crosslinked hydrocarbon polymer is present in the range of 2 percent by weight to 30 percent by weight of the solid electrolyte interface.
